(19) United States
(12) Patent Application Publication
(10) Pub. No.: US 2008/0038445 A1
(43) Pub. Date: Feb. 14, 2008

(54) DISPOSABLE BEVERAGE CONTAINER AND/OR DRINKING IMPLEMENT FUSED WITH SUGAR SYRUP

(76) Inventor: Felix Mendelson, Capitola, CA (US)

Correspondence Address: Walter K. Coronel, 140 Anzavista Ave. #1, San Francisco, CA, 94115, US

(21) Appl. No.: 11/621,511

(22) Filed: Jan. 9, 2007

Related U.S. Application Data
(60) Provisional application No. 60/837,506, filed on Aug. 14, 2006.

(51) Int. Cl. A23G 3/00

(52) U.S. Cl. 426/660

(57) ABSTRACT

A device for creating a sweet sensation is described herein. Typically, the device is made by fusing Syrup to a beverage container, lid for a beverage container, or a device attaching to a beverage container. The beverage container is filled with an unsweetened beverage and the beverage is consumed while palpating the Syrup with the tongue.

### CLAIM OF PRIORITY

This application claims priority under 35 U.S.C. 119(e) to U.S. Provisional Patent Application Ser. No. 60/837,506, filed on Aug. 14, 2006 and entitled “Sweelix™ container” which is incorporated herein by reference.

### BACKGROUND

An ever increasing proportion of the United States and developed world population is overweight or at risk of becoming overweight. This is a worrying long term trend which shows no signs of abating. Today, one out of every five children in the United States may be categorized as obese. Obesity and health concerns associated with obesity, such as diabetes, continue to affect the quality of life of the populations impacted and burden the developed worlds' health care systems. The trend toward an overweight population has been linked to a diet high in refined sugars.

The business community had responded and continues to respond to the demand for reducing sugar consumption by creating and marketing non-sugar sweeteners and non-sugar sweetened beverages. Nevertheless the distinctive and satisfying sweetness of sugar continues to be imitated but has thus far resisted duplication. A variety of artificial sweeteners continue to be unable to fool the taste buds, and the over-consumption of hot and cold beverages sweetened with refined sugar continues. The recommended daily allowance of calories from sugar is ten teaspoons. However, the average American consumes fifty-three teaspoons of sugar daily.

There exist a number of inventions directed to enhancing the flavor of beverages, for example, U.S. Pat. No. 3,545,980 to Stanger is directed to a combination straw and flavoring for sipping drinks and the like with a candy mouthpiece integrally connected therewith.

U.S. Pat. No. 6,565,899 to Cecere is directed to a novelty device formed of the combination of a drinking straw, bottle cap, and lollipop type edible candy to be attached to a beverage bottle allowing the consumer to simultaneously enjoy and taste the flavors of the lollipop and a liquid beverage.

U.S. Pat. Appl. Publ. 2006/0222743 to Bikas-Smith is directed to a method for making a candy-coated beverage container, typically a disposable cup, includes attaching a confection onto or adjacent to the rim of the container of the cup such that upon inserting the rim into one's mouth, the taste of the confection is imparted to the mouth.

The patent references discussed above would not fill the changing needs of Americans and the global population to decrease sugar intake. The prior art teaches devices which increase sugar intake by adding sugar to already sweetened beverages by adding flavors and candy. These ideas of adding flavor and candy run counter to the idea of sugar reduction and instead increase sugar consumption. Because of this, there remains a need for a device to cause a beverage to taste sweet while decreasing the consumption of sugar.

### SUMMARY OF THE INVENTION

The present invention, roughly described, pertains to a device which creates a sweet sensation in the mouth. When using the device, a person consumes the beverage while his or her tongue palpitates Syrup. This device fools the brain into believing that an unsweetened beverage is sweetened.

Typically, Syrup is fused to a beverage container, lid for a beverage container, or a device for attaching to a beverage container. The beverage container is filled with an unsweetened beverage. The consumer drinks the beverage experiencing a perception of sweetness. This occurs while the tongue palpates the sweetening device. The consumer's experience of sweetness obviates the need for sugar dissolved in the beverage and decreases the sugar consumed because very little sugar is consumed in creating the sweet perception in this manner when compared with drinking a sweetened beverage.

These and other objects and advantages of the present invention will appear more clearly from the following description in which the preferred embodiments of the invention have been set forth in conjunction with the drawings.

### BRIEF DESCRIPTION OF THE DRAWINGS

The accompanying drawings illustrate the invention. In such drawings:

FIG. 1 depicts a device for creating a sweet sensation utilizing a lid for a disposable cup lid onto which Syrup has been fused.

FIG. 2 depicts a device for creating a sweet sensation utilizing a can onto which Syrup has been fused as well as a cover for covering the Syrup.

FIG. 3 shows a device for creating a sweet sensation capable of being attached onto a variety of disposable containers; and shown is a disposable cup to which the device has been attached.

FIG. 4 shows a device for creating a sweet sensation utilizing a lid for a disposable cup lid onto which Syrup has been fused. This lid adds a spout to which Syrup is fused to.

### DETAILED DESCRIPTION OF THE INVENTION

As shown in the accompanying drawings, for purposes of illustration, the present invention's idea of reducing sugar consumption via a sweetening device resides in a disposable beverage container, a disposable beverage container lid, and/or an attachable drinking implement fused with Syrup.

Beverages for adults and children are contemplated. The devices depicted may be used in conjunction with any beverage including such beverages as water, soda (unsweetened), juice, tea, coffee, sparkling water, and generally all beverages which traditionally may be consumed sweetened.

The sweetener attached may be of any flavor, and made of a hardened sugar water syrup. A method, by no means the only method, for making and fusing the Syrup, as appreciated by anyone skilled in the art of candy making, contemplates heating granulated sugar and water, cooling this Syrup briefly, and while still malleable, applying the Syrup to a substrate, the substrate being a disposable beverage container, lid, or pin. Next, the Syrup is further cooled thereby forming a bond between the substrate. Cooling fuses the Syrup to the substrate.

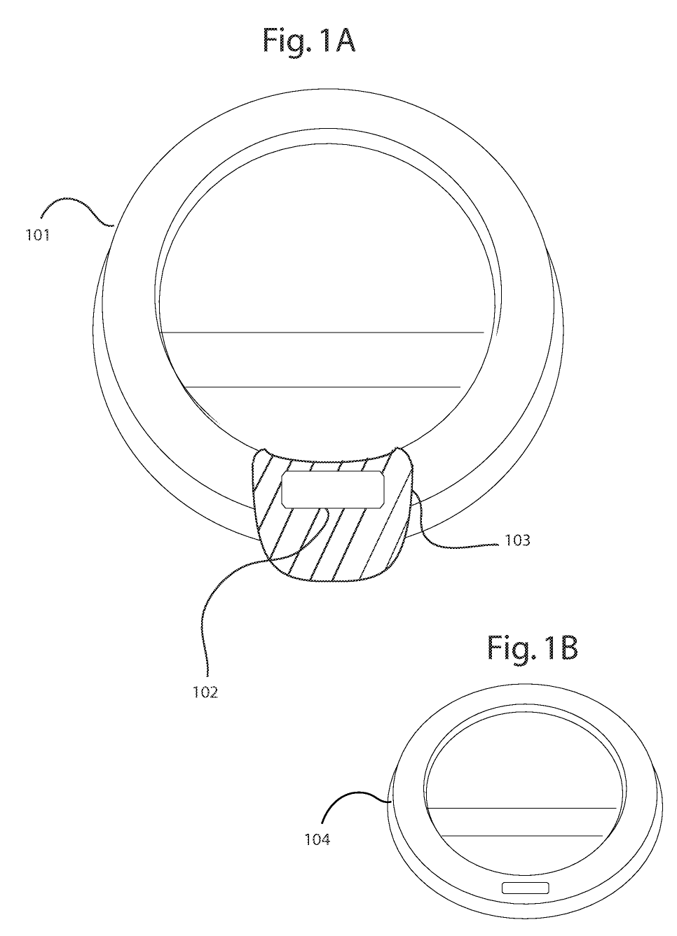

With reference now to FIGS. 1A-B, depicted is a device for creating a sweet sensation, lid 101 having a hole 102 and Syrup 103 fused to it is illustrated. The lid has a hole 102 through which the beverage contained within the beverage container may be consumed while the tongue palpates the Syrup. Lid 104 depicts a lid absent the Syrup prior to fusing the Syrup.

The lid may be formed by creating the Syrup as described above, then fusing the syrup to the lid such that the Syrup covers the portion of the lid containing the drinking hole Syrup sufficiently overlapping the edge of the lid to allow for easy contact with the consumer's tongue. An implement, such as a rod, may then be passed through the hardening Syrup into the lid's drinking hole while the Syrup is still malleable to create a hole in the Syrup. This hole in the syrup will allow the beverage to be consumed simultaneously with the tongue palpating the Syrup.

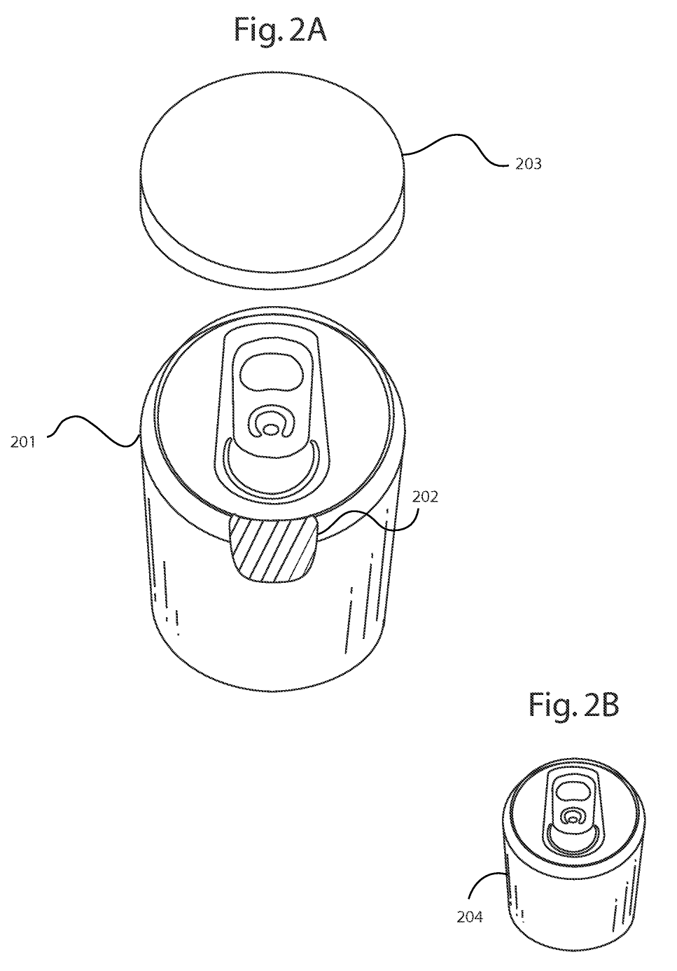

With reference now to FIGS. 2A-B, depicted is a device for creating a sweet sensation, a can 201, which has a circular surface and has a mouth and Syrup 202 fused about the mouth. The can has a cover 203 which protects the Syrup. Can 204 is a can absent Syrup prior to the fusing of the Syrup. Fusing of the Syrup 202 to the can 201 may be by applying Syrup to the can 201 and cooling the Syrup.

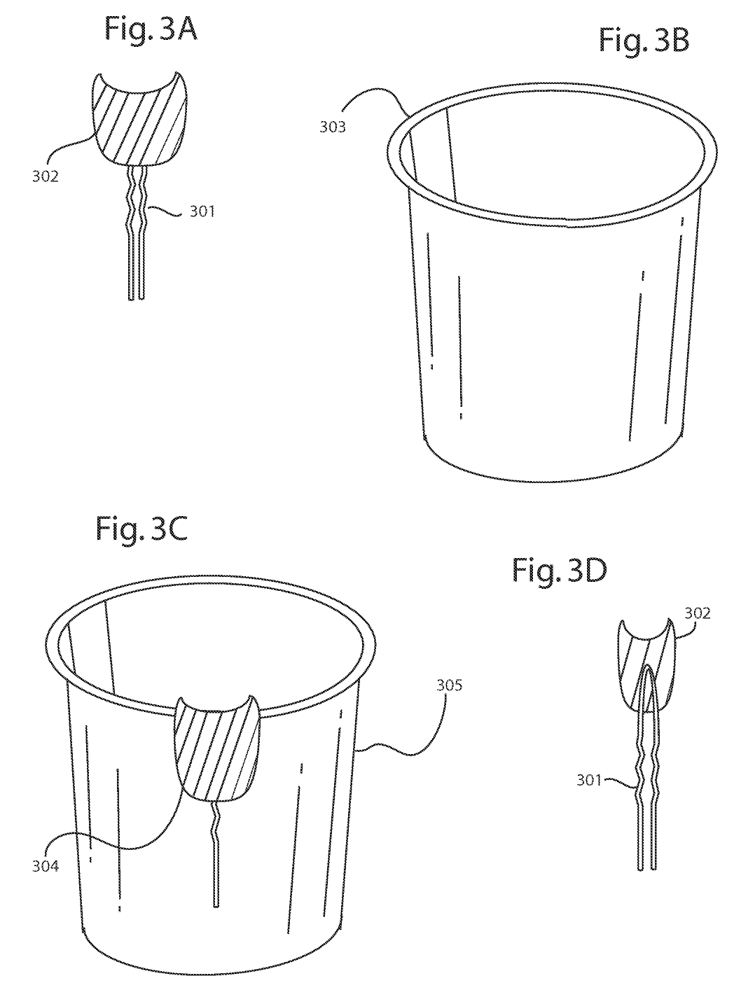

With reference now to FIGS. 3A-B, depicted is a device for creating a sweet sensation 301 having two prongs and having Syrup 302 fused to it at the point where the two prongs connect. The device 301 is also depicted as attached to a cup 303 where the two prongs are holding the device to the cup by applying tension between them. Fusing the Syrup to the device may be achieved by applying malleable Syrup to the device 301 and then cooling the Syrup.

With reference now to FIG. 3C, depicted is a device for creating a sweet sensation having Syrup 304 fused and attached to a cup 305.

With reference now to FIG. 3D, a device for creating a sweet sensation 301 capable of clipping onto many distinct types of disposable beverage containers via a constricting action is shown.

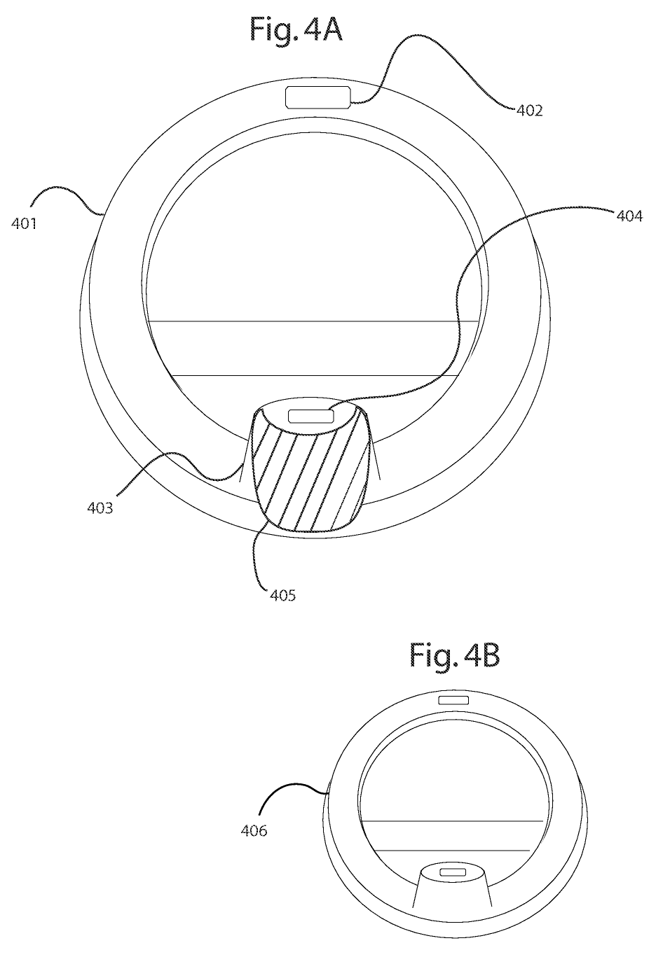

With reference now to FIG. 4A, a device for creating a sweet sensation 401 is depicted having Syrup 405 fused to spout 403 and a venting hole 402. Hole 402 and hole 404 are diametrically opposed one from the other. First hole, venting hole 402 allows air to enter the cup while the beverage is consumed through second hole 404. At the same time that the beverage is consumed through hole 404 the tongue may palpate Syrup 405 which is fused about said spout.

With reference now to FIG. 4B, depicted is a lid absent Syrup prior to fusing of the Syrup.

The foregoing detailed description of the invention has been presented for purposes of illustration and description. It is not intended to be exhaustive or to limit the invention to the precise form disclosed. Many modifications and variations are possible in light of the above teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

I claim:

1. A device for creating a sweet sensation, comprising:
A substrate wherein the substrate is a can, a lid or a pin; and
Syrup fused to the substrate;

2. The device of claim 1, wherein the substrate is a can having a surface generally circular;

3. The device of claim 2, further comprising a mouth wherein said Syrup is fused about said mouth.

4. The device of claim 2, further comprising a cover for the can, said cover covering the Syrup.

5. The device of claim 1, wherein the substrate is a pin said pin being generally in the shape of a U having two prongs capable of applying tension between the two prongs.

6. The device of claim 5, wherein said Syrup is fused to the pin at the point where the two prongs of the pin connect.

7. The device of claim 1, wherein the substrate is a lid being generally circular.

8. The device of claim 7, further comprising a first hole wherein said syrup is fused about said hole.

9. The device of claim 8, further comprising a second hole wherein said holes are about the circle diametrically opposed to one another and said Syrup is fused about said hole.

10. The device of claim 8, further comprising a spout having a base and a tip, and a second hole being at the tip of the spout, said Syrup being fused about the spout.

11. A method for making a device for creating a sweet sensation comprising:
Providing a substrate wherein the substrate is a can, a lid or a pin;
Providing Syrup; and
Fusing said Syrup to the substrate.

12. The method of claim 11, wherein the substrate is a can having a surface generally circular;

13. The method of claim 12, further comprising a mouth wherein said Syrup is fused about said mouth.

14. The device of claim 13, further comprising a cover for the can, said cover covering the Syrup.

15. The method of claim 11, wherein the substrate is a pin said pin being generally in the shape of a U having two prongs capable of applying tension between the two prongs.

16. The method of claim 15, wherein said Syrup is fused to the pin at the point where the two prongs of the pin connect.

17. The method of claim 11, wherein the substrate is a lid being generally circular.

18. The method of claim 17, wherein the substrate further comprises a first hole wherein said Syrup is fused about said hole.

19. The method of claim 18, wherein the substrate further comprises a second hole wherein said holes are diametrically opposed to one another and said Syrup is fused about said second hole.

20. The method of claim 18, wherein the substrate further comprises a spout having a base and a tip, and a second hole being at the tip of the spout, said Syrup being fused about the spout.
